(19) United States
(12) Patent Application Publication
(10) Pub. No.: US 2005/0243171 A1
(43) Pub. Date: Nov. 3, 2005

(54) Data acquisition and display system and method of establishing chain of custody

(76) Inventors: Charles A. Ross SR., Overland Park, KS (US); Keith E. Pierce, Stilwell, KS (US); David C. Owen, Olathe, KS (US); Laura E. Owen, Olathe, KS (US)

Correspondence Address: BLACKWELL SANDERS PEPER MARTIN LLP, 4801 Main Street, Suite 1000, KANSAS CITY, MO, 64112, US

(21) Appl. No.: 10/971,918

(22) Filed: Oct. 22, 2004

Related U.S. Application Data
(60) Provisional application No. 60/513,646, filed on Oct. 22, 2003.

(51) Int. Cl. H04N 7/18

(52) U.S. Cl. 348/148; 348/143

(57) ABSTRACT

A data display and acquisition system for mounting in a vehicle having an interior console and an aperture in the console. The system comprises a frame mountable in the aperture, a recording media housed in the frame and operable to store video data, and a video input in communication with the recording media to receive multiple types of data including video data and to transfer the video data to the recording media.

### CROSS-REFERENCE TO RELATED APPLICATIONS

This application is related to and claims priority from provisional application Ser. No. 60/513,646, titled DATA ACQUISITION AND DISPLAY SYSTEM AND METHOD OF ESTABLISHING CHAIN OF CUSTODY, filed on Oct. 22, 2003.

### FIELD OF THE INVENTION

The present invention relates to data acquisition and display systems and methods for recording, and more particularly to vehicle mounted data acquisition and display systems and methods of digitally recording and storing data in vehicle mounted systems.

### BACKGROUND OF THE INVENTION

Modern patrol cars are usually equipped with complex electronic equipment including radios, flashing lights, advanced radar-based speed measuring devices, and advanced laser-based speed measuring devices. However, the modern peace officer is confronted by complex and dangerous encounters, resulting in the need to reliably verify the officers reaction and more importantly, record evidence for use against criminal defendants. Thus, it is becoming increasingly common to equip patrol cars with surveillance cameras and video cassette recorders (VCRs) for recording video data collected by the cameras. Typically, major components of these surveillance systems, the VCR in particular, are mounted in the trunk of the patrol cars.

While the above described electronic equipment is generally useful, law enforcement officers (“officers”) are often unable to effectively operate them because they are located in hard-to-reach locations, and they are overly complex and difficult to operate. Moreover, it is often difficult and dangerous for officers to operate the equipment and surveillance system during high-speed pursuits, domestic disturbances, and other high-stress and high-activity encounters. Therefore, the electronic equipment, and particularly the surveillance systems, are often not activated until after an incident is resolved. For these reasons, the electronic equipment and surveillance systems are often underutilized and valuable data (e.g., video and speed data) is often not recorded.

Also, conventional electronic and surveillance equipment often record a voluminous amount of data, at least some of which is of little real value. Moreover, electronically collected data is often difficult to organize, retrieve, warehouse, and sort and therefore may be of little value.

Additionally, there is an increasing demand for systems that monitor and record the activity of officers and/or suspects during arrests, altercations, vehicle searches, and traffic stops. More particularly, it is thought that by recording the activities of officers and suspects, incidents of police brutality and false allegations of police brutality can be reduced and/or eliminated.

### SUMMARY OF THE INVENTION

To address these and other concerns, the present invention provides, among other things, a video recording apparatus for mounting in a vehicle having an interior console and an aperture in the console. The apparatus comprises a frame mountable in the aperture, recording media housed in the frame and operable to store video data, and a video input in communication with the recording media to receive video data and to transfer the video data to the recording media.

The present invention also provides a video recording apparatus for mounting in a vehicle having an interior console. The apparatus comprises a frame mountable in the console and housing a radio, a recording media housed in the frame and operable to store video data, and a video input in communication with the recording media to receive video data and to transfer the video data to the recording media.

Additionally, the present invention provides a video recording apparatus for mounting in a vehicle. The apparatus comprises a digital memory unit operable to store video data, a global positioning system operable to calculate location data and being in communication with the digital memory unit to transfer the location data to the digital memory unit, the digital memory unit associating the location data and the video data, and a search engine in communication with the digital memory unit and operable to search the digital memory unit for at least one of the location data and the video data.

Moreover, the present invention provides a video recording apparatus having a digital memory unit operable to store video data, a traffic velocity recording apparatus input in communication with the digital memory unit to receive traffic velocity data and to transfer the traffic velocity data to the digital memory unit, the digital memory unit associating the traffic velocity data and the video data, and a search engine in communication with the digital memory unit and operable to search the digital memory unit for at least one of the traffic velocity data and the video data.

Also, the present invention provides a video recording apparatus having a digital memory unit operable to store video data, a vehicle status data input in communication with the digital memory unit to receive vehicle status data and to transfer the vehicle status data to the digital memory unit, the digital memory unit associating the vehicle status data and the video data, and a search engine in communication with the digital memory unit and operable to search the digital memory unit for at least one of the vehicle status data and the video data.

Additionally, the present invention provides a method of operating a video recording apparatus and a method of recording and indexing data.

Other features and advantages of the invention will become apparent to those skilled in the art upon review of the following detailed description and drawings.

### BRIEF DESCRIPTION OF THE DRAWINGS

The present invention is further described with reference to the accompanying drawings, which show various constructions of the present invention. However, it should be noted that the invention as disclosed in the accompanying drawings is illustrated by way of example only. The various elements and combinations of elements described below and illustrated in the drawings can be arranged and organized differently to result in constructions which are still within the spirit and scope of the present invention.

FIG. 1 is a perspective view of a vehicle and a data acquisition and display system according to the present invention.

FIG. 2 is a front view of a vehicle console supporting a portion of the data acquisition and display system shown in FIG. 1.

FIG. 3 is a schematic illustrating the data acquisition and display system shown in FIG. 1.

FIG. 4A is a front view of a portion of the data acquisition and display system shown in FIG. 1 with a front panel in a closed position.

FIG. 4B is a side view of a portion of the data acquisition and display system shown in FIG. 1 with the front panel in a closed position.

FIG. 5A is a front view of a portion of the data acquisition and display system shown in FIG. 1 with the front panel in an opened position.

FIG. 5B is a side view of a portion of the data acquisition and display system shown in FIG. 1 with the front panel in an opened position.

FIG. 5C is a top view of a portion of the data acquisition and display system shown in FIG. 1 with the front panel in a closed position and illustrating a latching mechanism.

FIG. 6 is a rear perspective view of a portion of the data acquisition and display system shown in FIG. 1.

FIG. 7A is a front view of a junction box of the data acquisition and display system shown in FIG. 1.

FIG. 7B is a rear view of a junction box of the data acquisition and display system shown in FIG. 1.

FIG. 7C is a left side view of a junction box of the data acquisition and display system shown in FIG. 1.

FIG. 7D is a right side view of a junction box of the data acquisition and display system shown in FIG. 1.

FIG. 7E is a top view of a junction box of the data acquisition and display system shown in FIG. 1.

FIGS. 8A and 8B are perspective views of a video camera of the data acquisition and display system shown in FIG. 1.

FIG. 9 is a perspective view of an external communication system of the data acquisition and display system shown in FIG. 1.

FIG. 10 is a perspective view of a central storage unit for use with the data acquisition and display system shown in FIG. 1.

FIGS. 11A-11C are flowcharts illustrating operation of a data acquisition and display system according to the present invention.

FIGS. 12A-12C illustrates a vehicle and a data acquisition and display apparatus according to an alternate construction of the present invention.

### DETAILED DESCRIPTION

The terms “first”, “second”, “third”, “right”, “left”, “forward”, and “rearward” are used herein and in the claims for purposes of description only and are not intended to imply any particular order, orientation, or importance.

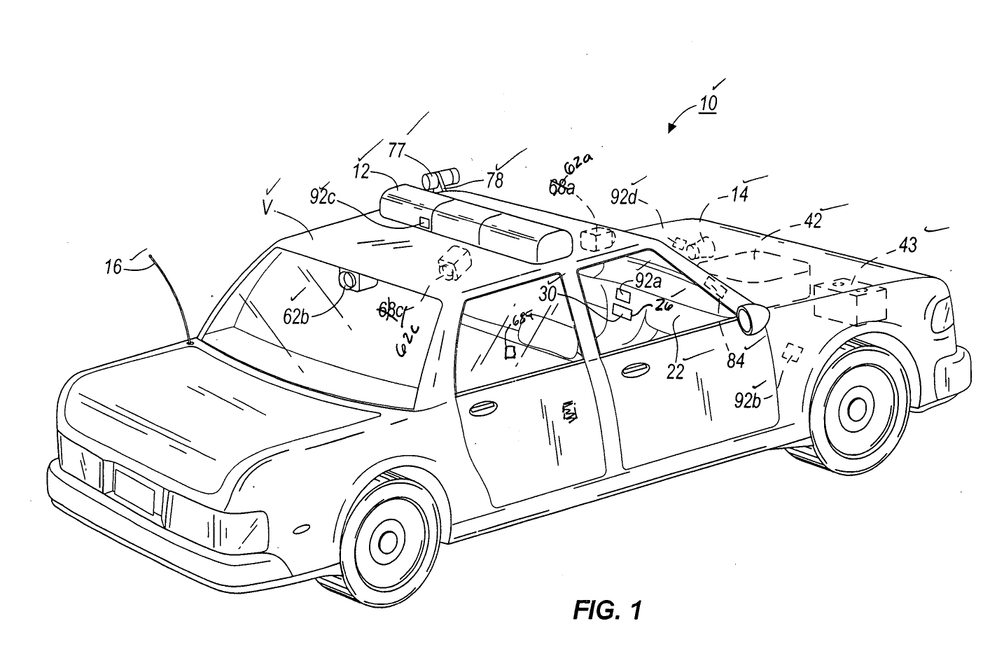

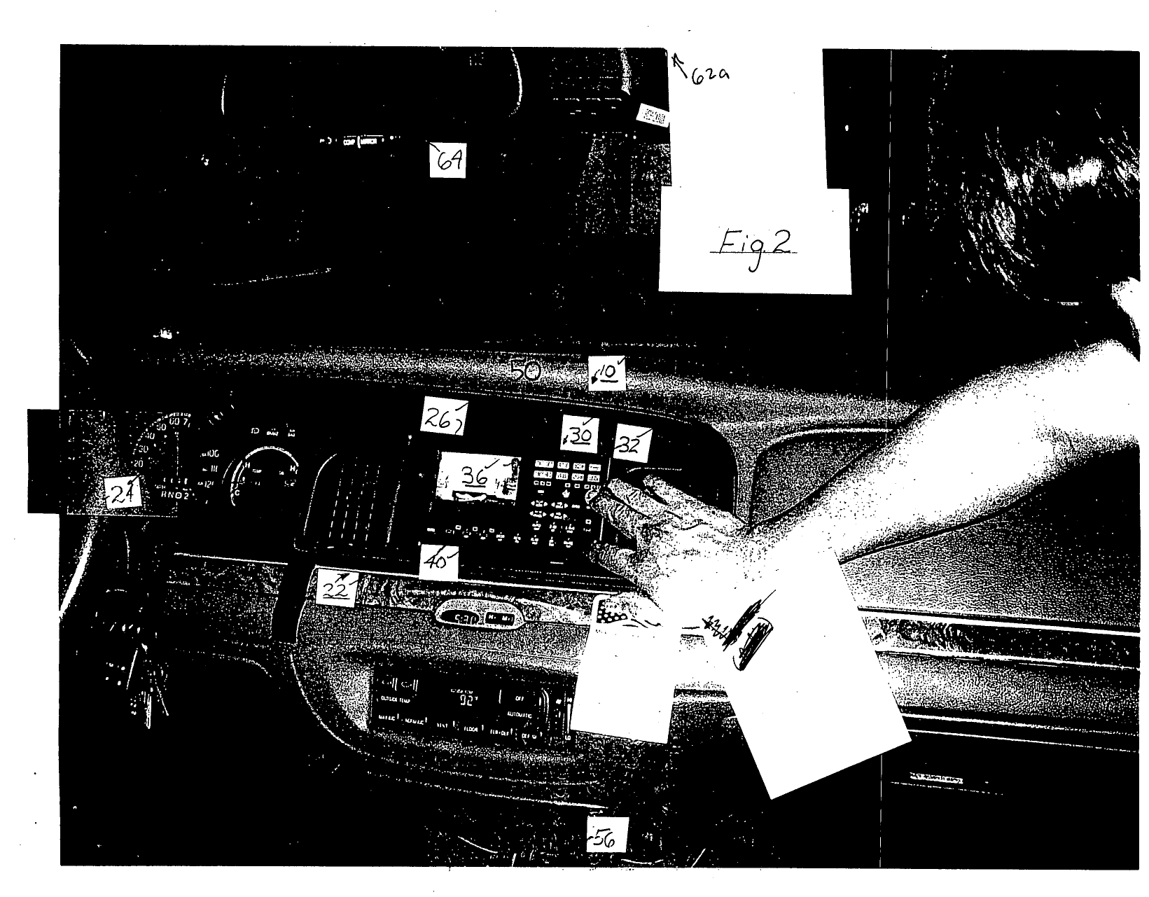

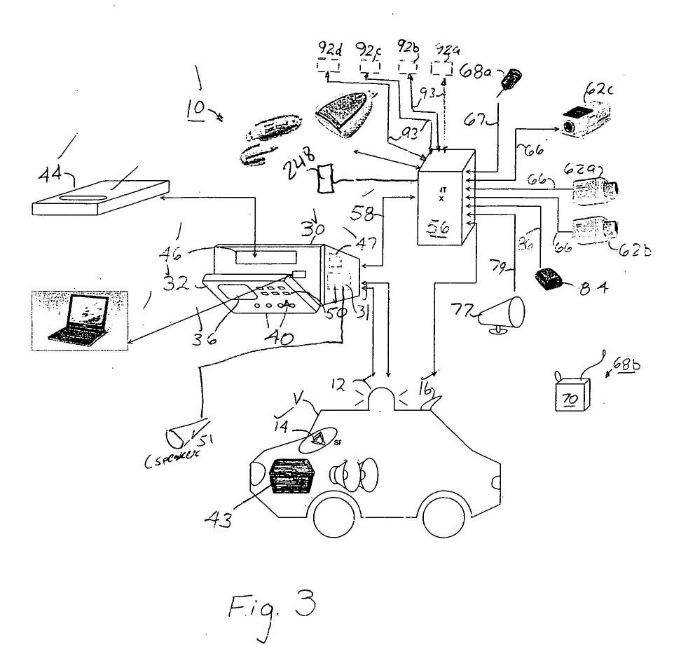

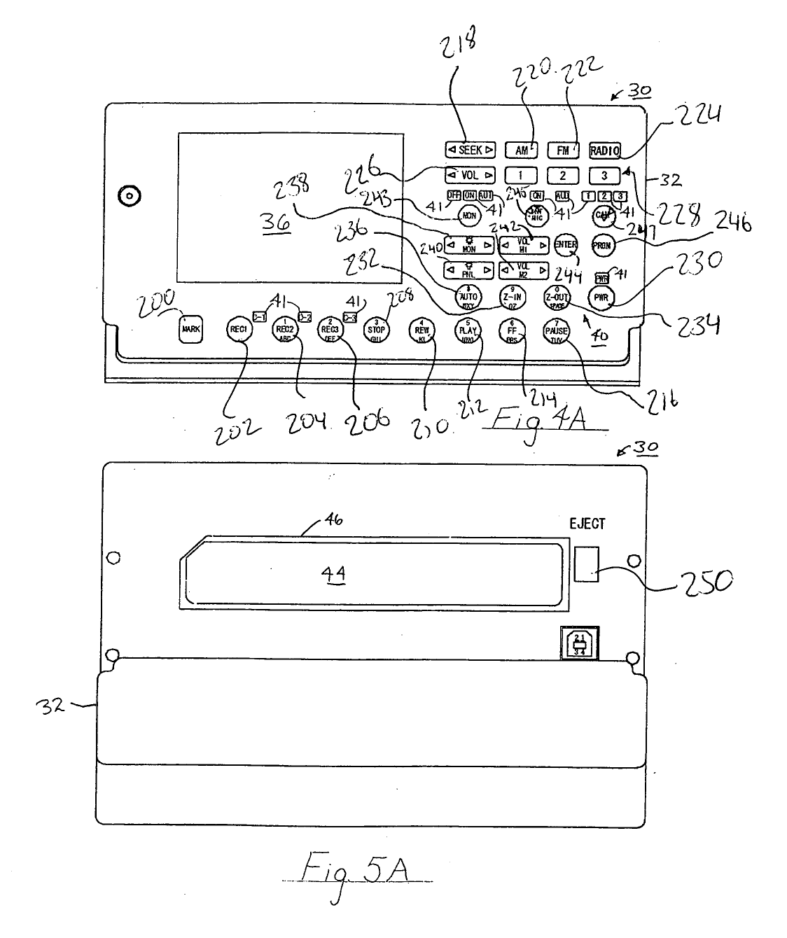

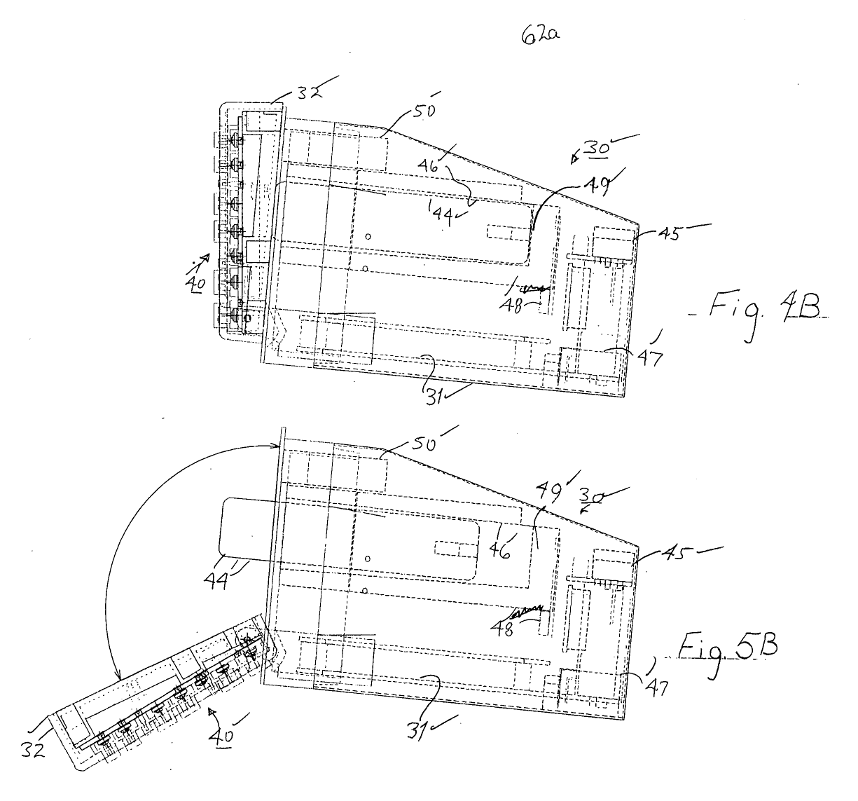

FIG. 1 illustrates a vehicle V supporting a data acquisition and display system or video recording apparatus 10 according to the present invention. In the illustrated construction, the vehicle V is a conventional police car (e.g., a Ford Crown Victoria, a Ford Police Interceptor, a Chevrolet Impala, etc.) with a roof mounted light bar 12, a siren 14, and an outboard antenna 16. However, in other constructions (not shown), the data acquisition and display system 10 of the present invention can alternatively be mounted on other motorized and non-motorized vehicles, such as, for example, vans, sport utility vehicles, trucks, motorcycles, airplanes, helicopters, and trailers. Additionally, while reference is made herein and in the figures to law enforcement vehicles, the data acquisition and display system 10 of the present invention can also be used with other vehicles (not shown), such as, for example, customs vehicles, department of natural resources (“DNR”) vehicles, drug enforcement agency (“DEA”) vehicles, ambulances, fire and rescue vehicles, and military vehicles.

Referring additionally to FIG. 2, the vehicle V includes an instrument console 22 positioned adjacent to the driver seat and the steering wheel 24. In the illustrated construction, the instrument console 22 is supported on the vehicle V dashboard. However, in other constructions (not shown), the instrument console 22 or portions of the instrument console 22 can be positioned between the front seats of the vehicle V, on the vehicle ceiling, or in another desirable location preferably within the driver's reach.

A central portion of the console 22 defines an aperture 26 adjacent to the steering wheel 24. In the illustrated construction, the aperture 26 is a double-din bin provided according to vehicle manufacturer specifications. The double-din bin is the name used by vehicle manufacturers for the in the dash compartment which is originally manufactured into the vehicle. The double-din bin normally is designed to support one or more of a car stereo, a compact disk player, a cassette player, a storage bin, an airbag, a global positioning system, a DVD player, an ash tray, and a vehicle climate controller. Therefore, the present invention allows the system 10 to be installed in a ready made in-dash location without significant modifications to the vehicle dash. Further, this location was designed for access by the driver and thus, provides convenient and safe access. More particularly, in the illustrated construction, the aperture 26 has the dimensions of the manufacturer provided double-din bin in a Ford Crown Victoria and is approximately 7.19 inches wide, 3.61 inches high, and 6.50 inches deep, or approximately 168.7 cubic inches. In alternate constructions, the aperture 26 has the dimensions of the manufacturer provided double-din bin of a Chevrolet Impala or another desired vehicle. In other constructions (not shown), the aperture 26 can be added to the vehicle V as an after-market modification and can have other dimensions. In still other constructions (not shown), the aperture 26 can be the vehicle's glove compartment.

The data acquisition and display system 10 includes a central unit 30 having a frame and being positioned in the aperture 26. In preferred constructions, the central unit 30 is design and sized to be received in the double-din bins of vehicles commonly used for law enforcement, such as, for example, the Ford Crown Victoria. In other constructions (as shown in FIG. 13), the central unit 30 is sized to be received in other apertures in other vehicles (e.g., the Chevrolet Impala). In this manner, the central unit 30 can be installed in a vehicle V without requiring that costly and time-consuming modifications be made to the vehicle V. More particularly, in the construction illustrated in FIG. 2, the central unit 30 is approximately 7.10 inches wide, 3.55 inches high, and 6.45 inches long and is sized to be received in the double-din bin of a Ford Crown Victoria. Preferably, it has less than 168 cubic inches of volume.

Referring additionally to FIG. 3, the central unit 30 houses a central processing unit or controller 31, which is programmable to coordinate operation of the data acquisition and display system 10. Additionally, the controller 31 includes instructions operable to search a recording media 44 (described below). The controller 31 also includes instructions to automatically adjust for daylight savings time change. This option can be activated and deactivated by the operator, to adjust for jurisdictions that do not follow the daylight savings time adjustment. A shock absorption and vibration isolation system supports the central unit 30 in the console 22 and protects the components housed in the central unit 30 from damage.

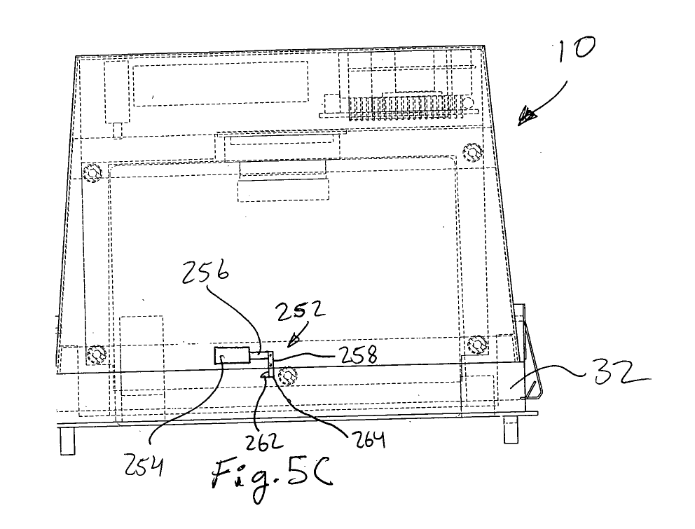

A front panel 32 is pivotably connected to the central unit 30 for movement between a closed position (shown in FIGS. 4A and 4B) and an opened position (shown in FIGS. 5A and 5B). During normal operation of the data acquisition and display system 10, the front panel 32 is maintained in the closed position. However, as explained in greater detail below, operators can move the front panel 32 toward the opened position to perform maintenance on the data acquisition and display system 10 and/or to install components in or remove components from the central unit 30.

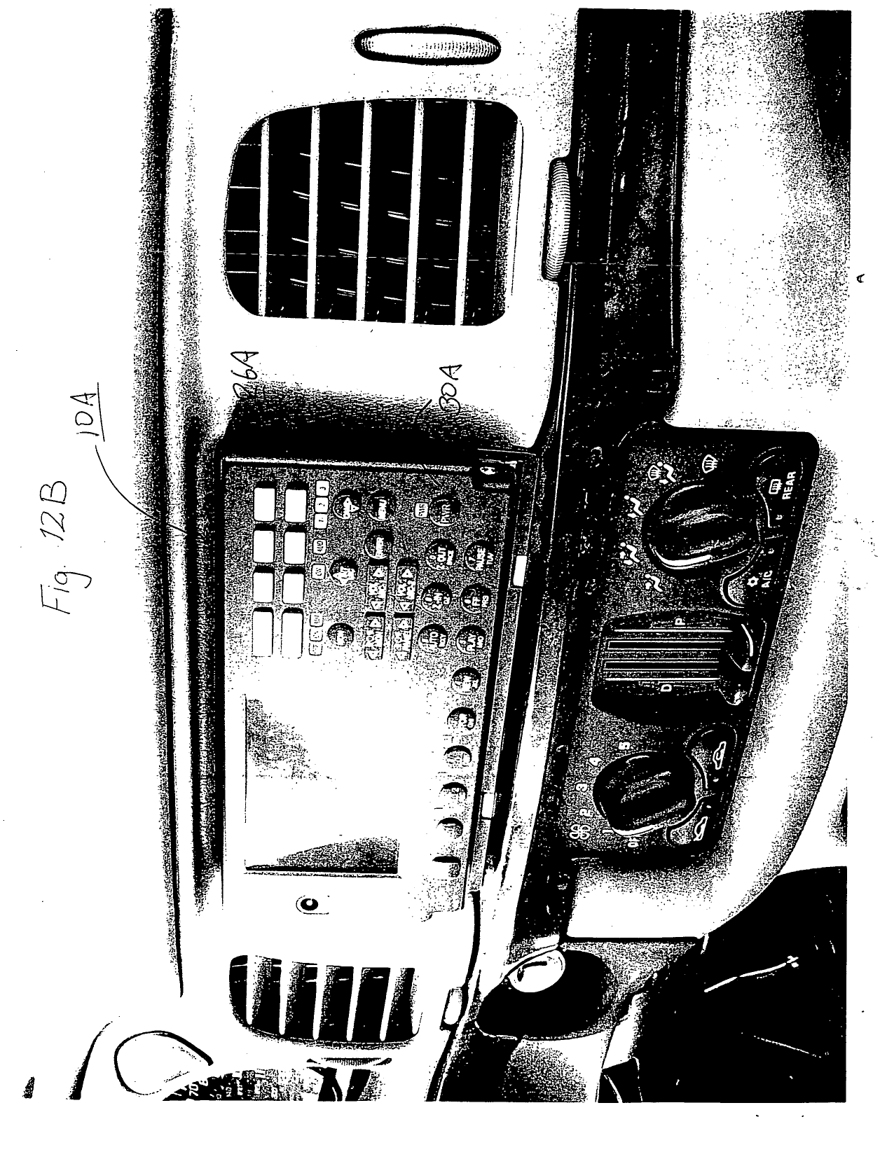

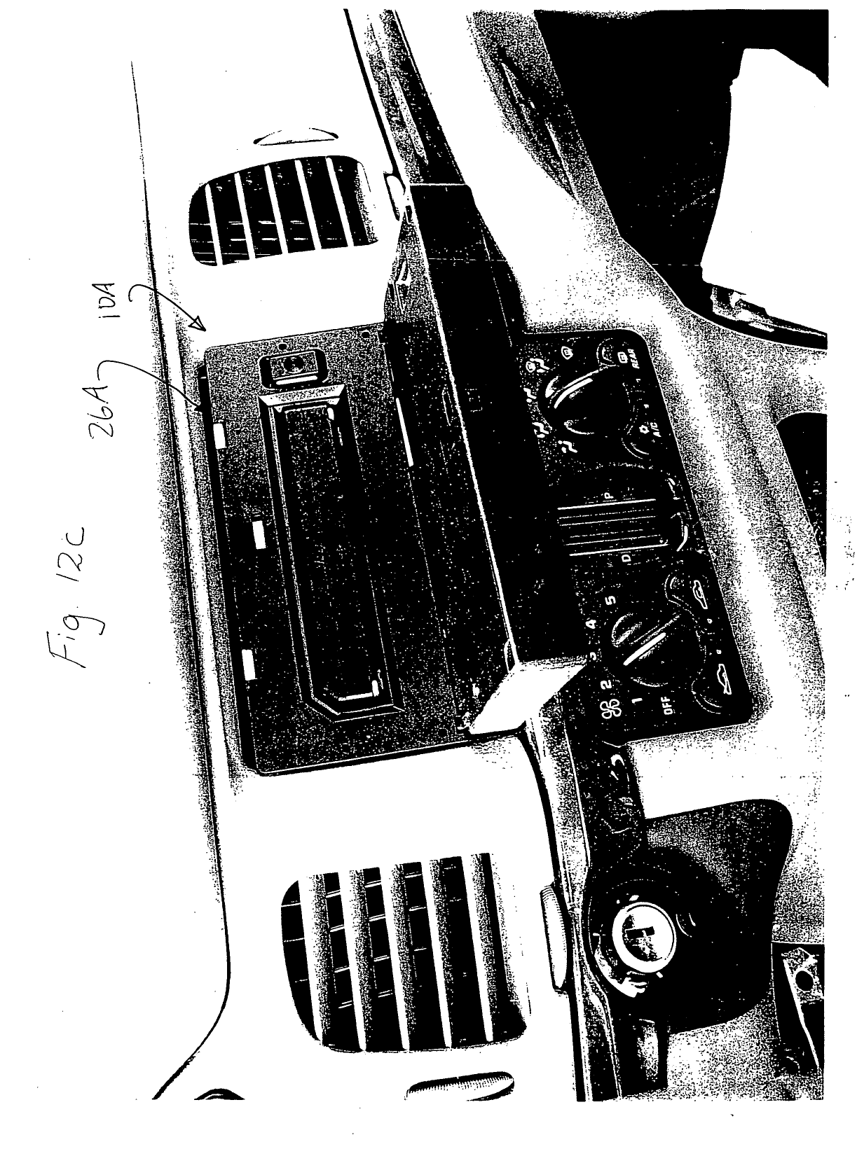

Referring additionally to FIG. 5C, to move the front panel 32 from the closed position to the opened position, an operator depresses one or more buttons located on the front panel 32 to release a first latching mechanism 252. A biasing mechanism (not shown), then moves the front panel 32 toward the opened position in a controlled fashion. The latching mechanism preferably utilizes a solenoid switch 254 to move a piston 256 laterally or left to right in the housing. The piston is pivotally attached to a lever arm 258, which is pivotally attached to the housing. The lever arm 258 extends out of the housing through an aperture 260 (FIG. 12C) in the front panel 32. A tooth 262 protrudes from the lever arm inside the front panel. When the front panel is latched, the piston is extended, so that the free end 264 of the lever arm moves toward the switch 254 until the lever arm contacts the edge of the aperture 260, and the tooth 262 engages the inner side of the front wall of the front panel. When the appropriate code is entered, the piston is retracted (moved left) and the lever arm pivots the free end 264 away from the switch disengaging the tooth 262 from the front panel. To move the front panel 32 from the opened position to the closed position, the operator grasps the front panel 32 and pivots the front panel 32 toward the central unit 30 until the latching mechanism secures the front panel 32 in the closed position.

In some constructions (not shown), the latching mechanism includes a lock (e.g., a mechanical locking mechanism, an electronic lock, etc.). In these constructions, only authorized operators having the correct key or key code can move the front panel 32 from the closed position to the opened position.

The front panel 32 includes a monitor or video display screen 36 and a user interface or control pad 40. In the illustrated construction, the video display screen 36 is a 3.8 inch flat color thin film transistor (“TFT”) liquid crystal display (“LCD”) screen. However, in other constructions other conventional display screens can be used, including black and white screens, picture tube screens, and high definition screens. The user interface 40 includes a number of controls, which are preferably buttons, though knobs, and dials may be used for controlling operation of the data acquisition and display system 10. In some constructions, at least a portion of the user interface 40 includes soft rubber buttons and back lighting to facilitate operation of the data acquisition and display system 10 at night or in other low lighting environments.

More particularly, in the illustrated construction (see FIGS. 2 and 4A), the user interface 40 includes a number of buttons for controlling operation of the video cameras (described below) and operating the video playback function (described below), including a “MARK” button 200, three record buttons 202-206 (“REC 1”, “REC 2”, and “REC 3”), a “STOP” button 208, a rewind or “REW” button 210, a “PLAY” button 212, a fast forward or “FF” button 214, and a “PAUSE” button 216. The user interface 40 also includes a number of radio control buttons, including a rocking “SEEK” button 218 (with up and down arrows), an “AM” button 220, an “FM” button 222, a “RADIO ON/OFF” power button 224, a rocking type radio “VOLUME” control button 226 (with up and down arrows), and preset radio station buttons “1”, “2”, and “3” 228. In addition, the user interface 40 includes a number of system control buttons, including a system “POWER” button 230, a camera zoom in or “Z-IN” button 232, a camera zoom out or “Z-OUT” button 234, an “AUTO” button 236, rocking type display screen adjustment buttons 238-240 “O MON” for adjusting the screen brightness and “PLN” for adjusting back lighting of the user interface 40, microphone volume buttons 242 labeled “VOL EXT” and “VOL INT”, an “ENTER” button 244, a “MENU” button 246, a “MON” button 243 for selecting screen display options, an “INT MIC” button 245 for activating an internal microphone 68a (described below), and a camera toggle button 247 (labeled “CAM”). There are three indicator lights, numbered 1, 2, and 3, above the CAM button 247, so that the operator can tell which camera is in currently displayed. Additionally, in some constructions, the REC 2 button 204 includes the letters “ABC” and the numeral “1”, the REC 3 button includes the letters “DEF” and the numeral “2”, the STOP button includes the letters “GHI” and the numeral “3”, the REW button includes the letters “JKL” and the numeral “4”, the PLAY button includes the letters “MNO” and the numeral “5”, the FF button includes the letters “PRS” and the numeral “6”, the PAUSE button includes the letters “TUV” and the numeral “7”, the AUTO button includes the letters “WXY” and the numeral “8”, the Z-IN button includes the letters “QZ” and the numeral “9”, and the Z-OUT button includes the word “SPACE” and the numeral “0”. In constructions having letter buttons, the letter buttons can be used to enter text messages into and/or upload data onto the data acquisition and display system 10. The user interface 40 also includes a number of indicator lights 41 (shown in FIG. 4A), which indicate, for example, when the system power is on or off, when the radio is on or off, and which camera is transmitting video data to the recording media 44 (described below). For additional convenience, an acknowledgment tone is sounded when a button is pressed. The functions of the various buttons and indicator lights 41 are explained in greater detail below.

The vehicle engine 42 and/or the vehicle battery 43 provide power to the data acquisition and display system 10. Additionally, as shown in FIGS. 4B and 5B, the central unit 30 houses an internal power supply 45 (e.g., a battery, a fuel cell, etc.), which provides backup power to the data acquisition and display system 10 to maintain operation of the data acquisition and display system 10 if the power supply from the vehicle engine 42 and/or the vehicle battery 43 is interrupted.

As shown in FIGS. 3, 4A, 4B, and 5B, the central unit 30 also houses a high grade or vehicle grade recording media 44 (e.g., a digital memory unit) in a drive slot 46. The recording media 44 is operable between approximately −20° C. to approximately 70° C. and is held in the central unit 30 by a second latching mechanism 49 and is protected from theft and/or damage by the front panel 32. To remove the recording media 44 from the central unit 30, an operator moves, preferably pivots, the front panel 32 toward the opened position and depresses an “EJECT” button located on the front panel 32 (see FIG. 5A). In this manner, the operator can remove and/or replace the recording media 44 as needed. Additionally, the recording media 44 can be removed from the central unit 30 and can be moved to a remote location to facilitate the downloading or uploading of data. For example and as explained in greater detail below, after an arrest or at the end of a shift, an operator can remove the recording media 44 from the central unit 30 and bring the recording media 44 to a headquarters building where data can be downloaded to or saved on a central computer or computer network.

In addition, in some constructions, the locking mechanism (described above) limits access to the recording media 44 so that only a limited number of operators can access the recording media 44. In this manner, the evidentiary quality of data stored on the recording media 44 can be preserved and data tampering can be prevented. This method secures the chain of custody and limits the number of people required to testify to establish the chain of custody. For example, the locking mechanism can be locked so that patrol officers cannot open the front panel 32 and only supervisory level officers (e.g., sergeants, lieutenants, captains, etc.) can gain access to the recording media 44.

The central unit 30 also houses a heating unit 48 (see FIGS. 4B and 5B) located in the drive slot 46. The heating unit 48 is in communication with the controller 31 and temperature sensors 248 shown schematically in FIG. 3. When the temperature sensors record a temperature below a predetermined value, preferably below about 50° F., the controller 31 activates the heating unit 48 to maintain the temperature of the controller 31 and the recording media 44 above the predetermined value.

The central unit 30 also houses a clock 47 (see FIGS. 3, 4B, and 5B), which is programmed to display the time and/or date on the display screen 36. Also, as described below, the clock 47 is in communication with the controller 31 and the recording media 44. In this manner, the controller 31 and the recording media 44 can coordinate and index time and date data with other recorded data, such as, for example, vehicle status data, vehicle location data, vehicle speed data, video data, and audio data. Additionally, the serial number or identification number of the recording media is included in the data, so that after the data has been downloaded and the recording media reused, the data can still be traced back to the original recording unit. Further, if desired, the patrol car and police officer are also identified in the data. Preferably, this data is overlayed on every frame.

As shown in FIG. 2, in some constructions, the central unit 30 also houses a conventional in car entertainment system such as a CD player, cassette player or AM/FM band radio 50. It should be understood that reference to radio 50 in the subsequent description is merely for illustrative purposes only and such reference is equally applicable to other entertainment systems. In these constructions, the AM/FM radio 50 is in communication with the antenna 16 and the vehicle speakers 51 (shown in FIG. 3). Moreover, as mentioned above, in some applications, installation of the central unit 30 in the aperture 26 in the console 22 requires the removal of the vehicle's manufacturer-installed AM/FM radio. In these applications, the AM/FM band radio 50 replaces the vehicle's manufacturer-installed radio and provides the passengers with audio entertainment and/or news and weather information. Operation of the radio 50 is controlled in a conventional manner using the RADIO ON/OFF button to activate the radio, the AM button to select the AM band, the FM button to select the FM band, the radio VOLUME control button to adjust the radio volume, and preset radio buttons 1, 2, and 3 to store and recall radio stations. In other constructions (not shown), the vehicle's sound system may include the radio 50 and one or more of a CD player, a cassette player, and a satellite radio.

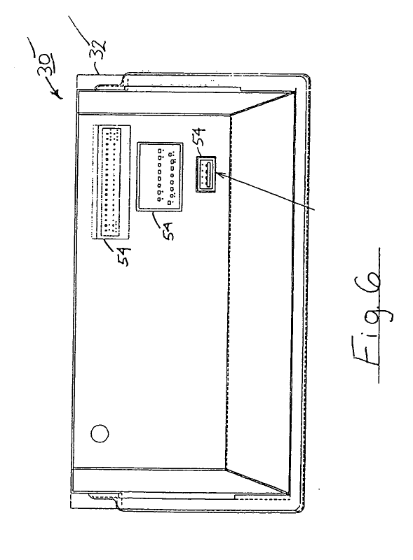

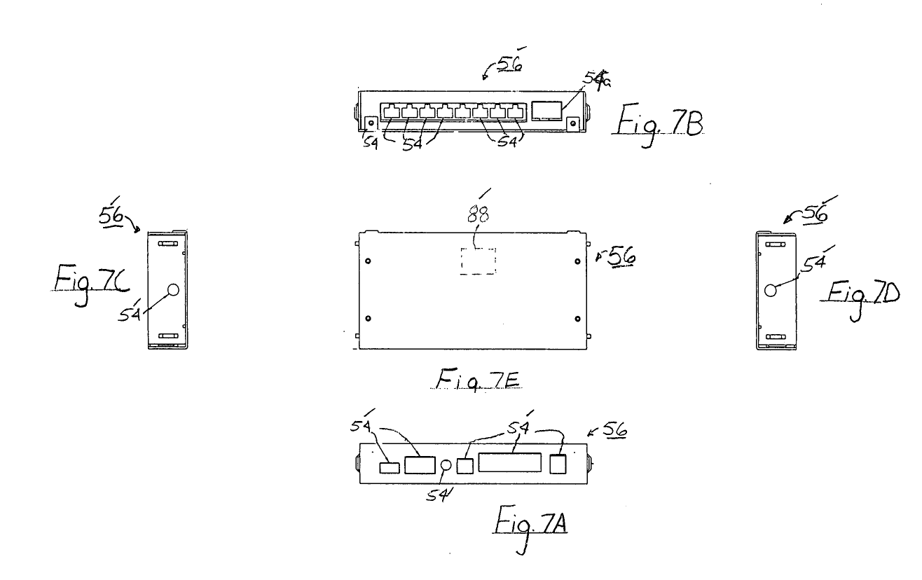

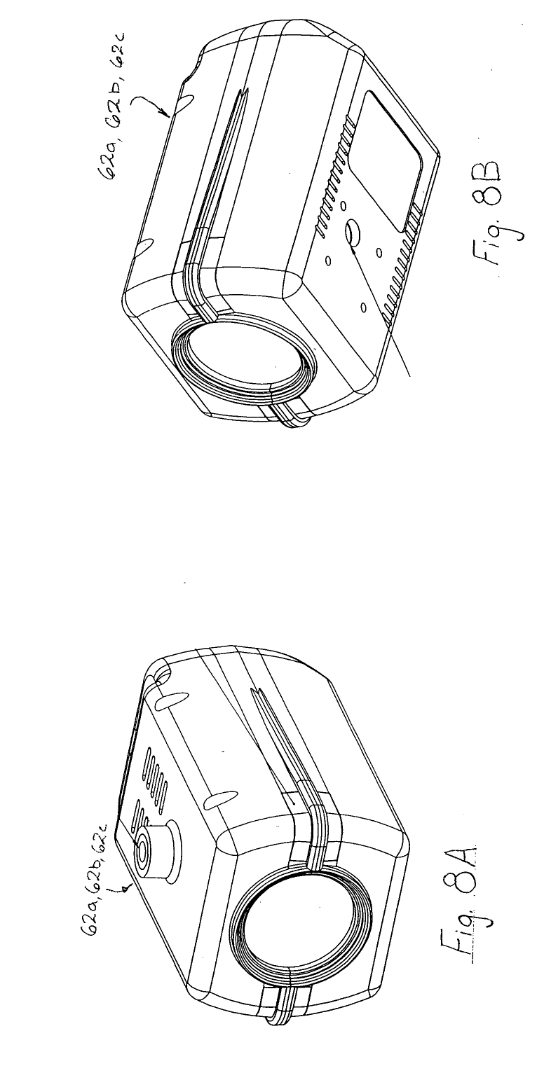

As shown in FIG. 6, the central unit 30 also includes a number of communication ports or jacks 54 such as, for example, USB ports, coaxial cable ports, phone jacks, RCA cable ports, etc. As shown schematically in FIG. 3, a line 58 extends between one of the communication ports 54 and a junction box 56, which also includes a number of communication ports 54. As shown in FIGS. 7A-7E, the junction box 56 also includes nonphysical-connection-based communication ports 54a, such as, for example, infrared and microwave receiving ports. In the illustrated construction, the junction box 56 is connected to the dashboard and is located under the instrument console 22. In other constrictions (not shown), the junction box 56 can be located in the vehicle trunk, under the driver seat 20, in a second aperture (not shown) in the instrument console 22, or in another suitable location in the vehicle V.

The data acquisition and display system 10 also includes a number of video cameras 62 arranged throughout the vehicle V. In the illustrated construction, a first camera 62a (shown in FIGS. 1-3) is positioned above the instrument console 22 and in front of the vehicle's rearview mirror 64. The first camera 62a is directed forwardly to record activity in front of the vehicle V, such as, for example, the actions of a suspect vehicle during a police pursuit or a traffic stop. A second camera 62b (shown in FIGS. 1 and 3) is supported on the vehicle's ceiling and is directed rearwardly toward the vehicle's rear window to record activity behind the vehicle V, such as, for example, suspect arrests, searches of suspects and suspect vehicles, and traffic stops. A third camera 62c (shown in FIGS. 1 and 3) is supported on the vehicle ceiling and is directed rearwardly toward the backseat to record the activity of passengers in the backseat.

In the illustrated construction, the first and second cameras 62a, 62b are digital video cameras capable of recording color images and the third camera 62c is a digital video camera capable of recording black and white images. However, in other constructions, the present invention can also include still cameras and infrared cameras, and low-ambient-light (i.e., night-vision) cameras. Additionally, while the illustrated construction includes three cameras 62, in other constructions (not shown), the present invention can include one, two, four, or more cameras. For example, in some constructions, cameras 62 are mounted on the vehicle ceiling and are directed toward the side windows to record activity on the right and left sides of the vehicle V. In still other constructions (not shown), one or more of the cameras 62 are remotely positionable so that the operator can adjust the direction of the cameras 62 to record activity in front of the vehicle V, to the left of the vehicle V, to the right of the vehicle V, behind the vehicle V, or inside the vehicle V.

Data recorded by the cameras 62 is transmitted across video lines 66 (illustrated schematically in FIG. 3) back to the junction box 56 and along line 58 from the junction box 56 to the controller 31 and the recording media 44 where the video data is stored and indexed for later retrieval. Also, as explained below, video data from the cameras 62 is indexed and coordinated or synchronized with other recorded data, such as, for example, date and time data, vehicle status data, vehicle location data, and audio data. In this manner, when the recorded video data is replayed, it is possible to determine when the video data was recorded, where the video data was recorded, the status of the vehicle V during video recording, the location of the vehicle V during video recording, and whether there was any verbal communication or other background sound during video recording. Also, in some constructions, the recorded data is also indexed and coordinated with a data acquisition and display system serial number or identifier. In this manner, when the recorded data is replayed or stored at another location, it is possible to determine which data acquisition and display system 10 recorded the data. All of this data can be useful for evidentiary purposes and for investigative purposes. More particularly, this data can be used during a court hearing to prosecute a suspect and/or to investigate allegations of inappropriate behavior by police officers. Additionally, because officers and suspects are likely aware of the presence of the cameras 62, many suspects and officers will avoid inappropriate behavior.

In an alternate construction, the data acquisition and display system 10 can include a remote handheld video camera (not shown) which can be carried by an operator to record video data when he leaves the vehicle V to chase a suspect or to investigate a building or another vehicle. When the operator returns to the vehicle V, the operator can upload recorded video data from the handheld camera to the controller 31 and the recording media 44 via one of the communication ports 54 for indexing and storage in the recording media 44. Alternatively, the camera could wirelessly communicate video data to the controller 31 or the data acquisition and display system 10, in real time or upon the conclusion of the recording session, or the camera could communicate with an extension cable back to communication port 54.

In some constructions, the recording media 44 records video data on a single channel. In these constructions, the controller 31 is programmed to record video data from one camera 62 (e.g., the first camera 62a) during normal operation. The operator can then select an alternate camera 62 (e.g., the second or third camera 62b, 62c) with the REC 1, REC 2, or REC 3 buttons as desired (e.g., when a passenger is in the backseat). In other constructions, the recording media 44 records two channels of video data simultaneously. In these constructions, the controller 31 is programmed to record video data on two channels from two cameras 62 (e.g., the first and second cameras 62a, 62b) during normal operation. The operator can then select an alternate camera configuration (e.g., the first camera 62a and the third camera 62c) as desired (e.g., when a passenger is in the backseat). The appropriate indicator or indicators are illuminated, so that the operator can tell which cameras are recording at a glance.

During normal operation and as mentioned above, the first camera 62a is directed forwardly and is focused to record activity occurring in a broad area in front of the vehicle V, the second camera 62b is directed rearwardly and is focused to record activity occurring in a broad area behind the vehicle V, and the third camera 62c is directed rearwardly and is focussed to record activity in the backseat. Additionally, in some constructions, an operator can remotely adjust the orientation of the first, second, and third cameras 62a, 62b, 62c to pan to the right, left, above, or below the predetermined focal points. The operator can also adjust the focal point of the first, second, and third cameras 62a, 62b, 62b and can zoom in or zoom out using the Z-IN and Z-OUT buttons.

Video data from the video cameras 62 can also be displayed on the display screen 36 in real time, so that an operator can discreetly monitor activity outside the vehicle V and/or activity of a passenger in the backseat. Alternatively, previously recorded video data can be played back on the display screen 36. In constructions of the data acquisition and display system 10 having multiple video cameras 62, the operator can toggle between the video cameras 62a, 62b, 62c using the CAM button to display data from any one of the video cameras 62a, 62b, and 62c on the display screen 36. Also, in constructions of the present invention in which video data from two cameras (e.g., the first and second cameras 62a, 62b) is simultaneously recorded, the operator can review previously recorded video data on the display screen 36 from either of the video channels by toggling between the two channels using the CAM button.

The data acquisition and display system 10 also includes audio recording apparatus or microphones 68. A first or internal microphone 68a (see FIGS. 1 and 3) is positioned in the backseat (not shown) to record a passenger's voice. Audio data recorded by the first microphone 68a is transmitted across a communications line 67 (shown schematically in FIG. 3) back to the junction box 56 and along line 58 from the junction box 56 to the controller 31 and the recording media 44 where the audio data is stored and indexed for later retrieval. Also, as explained below, audio data from the first microphone 68a is indexed and coordinated with other recorded data, such as, for example, date and time data, vehicle status data, vehicle speed data, vehicle location data, and video data. Additionally, in some constructions, the audio data is indexed and coordinated with a data acquisition and display system serial number or identifier. In this manner, when the recorded audio data is replayed, it is possible to determine when the audio data was recorded, where the audio data was recorded, the status of the vehicle V during recording, the location of the vehicle V during recording, and which data acquisition and display system 10 recorded the data. To prevent feedback and to obtain the best possible audio data, the controller 31 is programmed to deactivate the vehicle speakers 51 when the first microphone 68a is recording.

In some constructions, the data acquisition and display system 10 includes a second wireless or external microphone 68b (e.g., a walky-talky, a two-way radio, etc.). In these constructions, the microphone 68b transmits audio data in a known manner to one of the nonphysical-connection-based communication ports 54a on the junction box 56. Additionally, in these constructions, the operator can bring the second microphone 68b with him when he leaves the vehicle V to approach a suspect or to investigate a building or a parked vehicle.

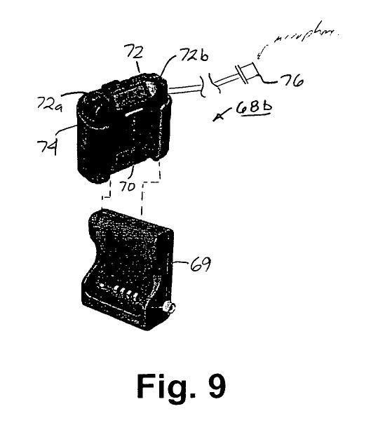

As shown in FIG. 9, in some constructions, the second microphone 68b includes a docking station 69 and a mobile unit 70. The docking station 69 can be mounted in the vehicle V, or alternately, can be located in a headquarters building. When the second microphone 62b is not in use, the mobile unit 70 can be placed in the docking station 69 to recharge the mobile unit's internal battery (e.g., a lithium-ion battery).

The mobile unit 70 includes a display screen 72 that displays the time and the channel frequency, a “TALK” button 72a, and a “CALL” button 72b. The display screen 72 also displays an icon (not shown) to alert the operator whether the mobile unit 70 is within range or out of range of the controller 31 and to indicate whether or not a communication line can be established between the mobile unit 70 and the controller 31.

In the construction illustrated in FIG. 9, the mobile unit 70 also includes a belt clip 74 and a corded microphone 76. The mobile unit acts as a wireless microphone for the system 10 and as a two way radio. During operation, the operator can clip the belt clip 74 on his belt and can clip the corded microphone 76 to his collar or lapel for convenient hands-free operation.

To communicate with other officers, a headquarters building, or a dispatcher, the operator depresses the TALK 72a button and speaks into the mobile unit 70 in a conventional manner. Audio data from the mobile unit 70 is transmitted across one of twenty channels in the 900 MHz range (e.g., between about 902 MHz and about 928 MHz) back to the junction box 56 and along line 58 from the junction box 56 to the controller 31 and the recording media 44 where the audio data is stored and indexed for later retrieval. Also, as explained below, audio data from the mobile unit 70 is indexed and coordinated with other recorded data, such as, for example, date and time data, vehicle status data, vehicle location data, vehicle speed data, video data, and the recording media serial number. In this manner, when the recorded audio data is replayed, it is possible to determine when the audio data was recorded, where the audio data was recorded, the status of the vehicle V during recording, and the location of the vehicle V during recording.

In addition to recording the audio data from the mobile unit 70, the controller 31 also transmits the audio data to the intended recipient (e.g., other officers, a headquarters building, or a dispatcher), or alternately, broadcasts the audio data to another operator in the vehicle V using the vehicle speakers 51. The mobile unit 70 can also receive audio data from other sources (e.g., from a headquarters, a dispatcher, another officer, the internal microphone 68a, etc.) in a conventional manner. In addition, in some constructions, audio data from other sources is recorded on the controller 31 and the recording media 44 and is indexed and coordinated with other recorded data for later retrieval. By embedding the recording media's identification in the data, the chain of custody for the evidence is further established.

If the operator is injured and/or unable to speak, the operator depresses the CALL button 72b to send a distress signal or an alert signal to the controller 31 and the recording media 44. When the CALL button 72b is depressed, a signal is sent from the mobile unit 70 to the controller 31 and the recording media 44 via communication line 58 and the junction box 56. The controller 31 and the recording media 44 then record the alert signal and coordinate and index the alert signal with other recorded data, including time and date data, vehicle location data, vehicle status data, vehicle speed data, and video data for later retrieval. The controller 31 also sends a distress signal to a second location (e.g., a headquarters, a dispatcher, etc.). The distress signal is voiced with a synthesized voice chip with location data corresponding to the location of the vehicle V and identification data including the operator's identification or badge number and the vehicle number. Additionally, in some constructions, the controller 31 displays an alert message on the display screen 36 and/or activates an alarm (not shown) in the vehicle V to alert vehicle occupants that the operator is in distress. Additionally, in some constructions, the alert signal is indexed and coordinated with a data acquisition and display system serial number or identifier. In this manner, when the recorded data is replayed, it is possible to determine when the alert signal was recorded, where the alert signal was recorded, the status of the vehicle V during recording, the location of the vehicle V during recording, and which data acquisition and display system 10 recorded the data.

The controller 31 also sends an alert signal to a second location (e.g., a headquarters, a dispatcher, etc.). The alert signal is encoded with location data corresponding to the vehicle location and identification data, including the operator's identification number or badge number and the vehicle number. Additionally, in some constructions, the controller 31 displays an alert message on the display screen 36 and/or activates an alarm (not shown) in the vehicle V to alert vehicle occupants that the operator is in distress.

As shown in FIG. 1, a speed measuring apparatus 77 (e.g., a radar-based gun or a laser-based speed gun) is mounted on a support bracket 78 on the driver side door and is operable to record the speed of target vehicles in a known manner. Speed data recorded by the speed measuring apparatus 77 is transmitted via line 79 (shown schematically in FIG. 3) to the controller 31 and the recording media 44. Speed data from the speed measuring apparatus 77 is then stored on the recording media 44. Additionally, the controller 31 coordinates and indexes the speed data with other recorded data, such as, for example, date and time data, vehicle status data, vehicle location data, audio data, and video data. Additionally, in some constructions, the speed data is indexed and coordinated with a data acquisition and display system serial number or identifier. In this manner, when the recorded audio data is reviewed, it is possible to determine when the speed data was recorded, where the speed data was recorded, the status of the vehicle V during recording, the location of the vehicle V during recording, and which data acquisition and display system 10 recorded the data.

In some constructions of the present invention, the controller 31 is programmed to record all speed data recorded by the speed measuring apparatus 77 on the recording media 44. In other constructions, the controller 31 is programmed to record only designated speed data on the recording media 44 to conserve memory space. For example, when an operator is using the speed measuring apparatus 77 to monitor traffic speeds, the operator can designate which speed data is recorded by pressing a record button on the central unit 30 to record a specific speed measurement. In this manner, the operator can selectively record speed data relating to, for example, speed limit violators only. In these constructions, when the operator selects data to be recorded, the speed data displayed on the speed measuring apparatus 77 is transmitted across line 79 to the controller 31 and the recording media 44 and is then coordinated and indexed with other recorded data.

The data acquisition and display system 10 also includes a global positioning system (GPS) 80. In the illustrated construction, the global positioning system 80 includes a GPS antenna 84 housed in the vehicle's passenger-side A-pillar (see FIG. 1) but may also be extended externally from the vehicle. The GPS antenna 84 receives location data from earth-orbiting satellites in a conventional manner and transmits the location data across communication line 86 (shown schematically in FIG. 3) to a GPS engine 88. In the illustrated constructions, the GPS engine 88 is housed in the junction box 56 and is in communication with the controller 31 and the recording media 44 via communication line 58.

The GPS engine 88 receives location data from the GPS antenna 84 and continually calculates the location of the vehicle V. The GPS engine 88 then transmits vehicle location data across line 58 to the controller 31 and the recording media 44 for storage on the recording media 44. Additionally, the controller 31 and the recording media 44 coordinates and indexes the location data with other recorded data, such as, for example, date and time data, vehicle status data, audio data, vehicle speed data, and video data. Additionally, in some constructions, the location is indexed and coordinated with a data acquisition and display system serial number or identifier. In this manner, the recording media 44 can be searched for vehicle location data given other recorded data, such as, for example, date and time data. In some constructions, the global positioning system 80 calculates the location data in the form of latitude and longitude coordinates, which are continuously displayed. In other constructions, the controller 31 sends or receives GPS latitude and longitude across line 58 to junction box 56 to a computer controller with mapping data embedded or DVD that is viewable on display system 10 on a P.C. laptop computer in vehicle V. In further constructions, the controller 31 and the recording media 44 store a number of maps. In these constructions, the controller 31 converts the position data provided by the global positioning system 80 from latitude and longitude coordinates into street names and approximate distances from cross streets.

The data acquisition and display system 10 also includes a mark and search feature, which allows the operator to identify a given location, based on GPS coordinates, and to recall that location later, or alternatively, to provide the location data to other personnel (e.g., to a police dispatcher or to the occupants of a second vehicle). This feature is particularly useful during pursuit and surveillance activities. For example, when a police car is pursuing a target vehicle and the occupant(s) of the target vehicle jettisons an item (e.g., evidence, a weapon, contraband, etc.), the operator can record the approximate location of the item so that after the pursuit, the operator or other personnel can return to the designated location to search for the item.

To mark a location, the operator depresses the MARK button located on the front panel 32 of the central unit 30. The controller 31 then saves the location data generated by the global positioning system 80 at the time that the MARK button was depressed. More specifically, a notation is embedded into the recording to identify the previous 200 frames and related GPS coordinate information. The designated location data is then displayed on the display screen 36 to confirm to the operator that the data display and acquisition system 10 has recorded the location data. Other recordings such as audio or video are also associated and related to the instance of the Mark thus allowing such recordings to be later identified and located in conjunction with the Mark.

The system and method of the present invention essentially provides for the recording of searchable parameters in addition to the audio and/or video data. A relationship between video, audio and search parameters is established utilizing some synchronous measure such as time. It would be understood by those skilled in the art that a wide variety of parameters may be captured and utilized as searchable items.

As shown in FIGS. 1 and 3, the data acquisition system 10 also includes a number of vehicle sensors 92 distributed throughout the vehicle V. In the illustrated construction, a first sensor 92a is positioned in the dashboard and receives vehicle speed data from the vehicle speedometer. A second sensor 92b is connected to the vehicle brakes and records breaking conditions (i.e., whether the brakes have been activated). A third sensor 92c is positioned to communicate with the light bar 12 to record whether or not the lights have been activated. A fourth sensor 92d is positioned to communicate with the siren 14 to record whether or not the siren 14 has been activated. The vehicle status sensors 92 record vehicle status data and transmit the vehicle status data across communication lines 93 (shown schematically in FIG. 3) to the controller 31 and the recording media 44 via the junction box 56 and communication line 58. The controller 31 and the recording media 44 then record the vehicle status data and index and coordinate the vehicle status data with other recorded data, including date and time data, video data, vehicle location data, and audio data. Additionally, in some constructions, the vehicle status data is indexed and coordinated with a data acquisition and display system serial number or identifier.

To assure that there is sufficient storage available for important data, the system is provided with an endless loop feature. The endless loop feature addresses the problem of limited video storage space. The limits on recording time conventionally require the recording system to be turned on and off and only used intermittently which can result in missed opportunities to record important events.

The endless loop records video for a limited time, such as 8 hours. The loop time can be set by the operator, and at the end of that time begins recording over previous recorded video. After completion of the loop time, there is preferably still empty disk space left that is reserved for further recording if the loop feature is shut off. Therefore, only a limited amount of video storage space is required, and the operator can stop this loop at any time to save the recorded video.

The endless loop storage media can be any media that is able to store a video recording. This includes magnetic media such as hard disk and tape. It includes optical storage such as CD and DVD. And it includes solid state memory such as RAM.

The system would employ the endless loop feature to allow the offer to constantly have the video system recording to document all events. If an important event occurs, the officer switches the system to normal record mode and the system permanently saves the video on the endless loop and begins recording normally into the reserved space. Thus, important events would be documented whereas without the endless loop feature, the event would have been lost because the officer did not have the recorder turned on.

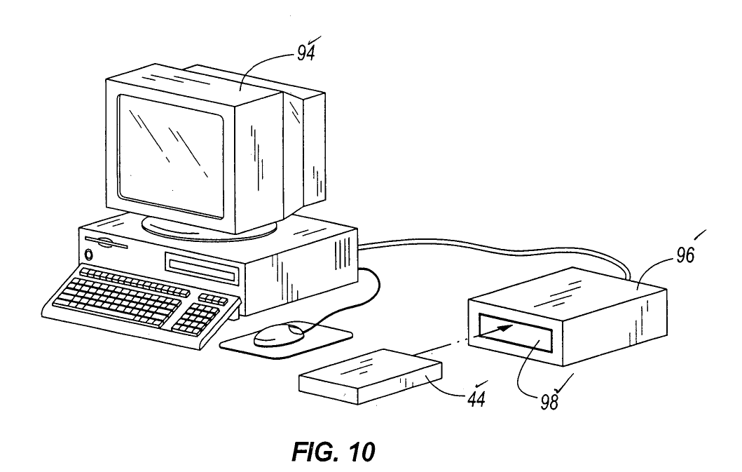

To download data from the data acquisition and display system 10, or alternately, to upload data onto the data acquisition and display system 10, the recording media 44 is removed from the control unit 30 and is transported to a central storage unit 94 (e.g., a computer, a computer network terminal, etc). As described above, in some constructions, a locking mechanism limits access to the recording media 44 and prevents unauthorized operators from opening the front panel 32. Therefore, in constructions having a locking mechanism, an operator enters the key code using the user interface 40, or alternately, inserts a mechanical key into a corresponding aperture (not shown) on the front panel 32. After the correct key is entered, a solenoid is activated to release the locking mechanism, so that the front cover can be pivoted to the open position. To assure that there is sufficient storage available for important data, the system is provided with an endless loop feature. The operator then moves the front panel 32 toward the opened position and depresses the EJECT button 250 to remove the recording media 44 from slot 46 in the central unit 30. The operator then inserts the recording media 44 into an adapter 96 (shown in FIG. 10), which includes a slot 98 configured to receive the recording media 44. Data can then be uploaded from the recording media 44 to the central storage unit 94, or alternately, from the central storage unit 94 to the recording media 44 in a conventional manner. After downloading and/or uploading is complete, the recording media 44 can be cleared to provide additional storage space for new data.

Data downloaded from the recording media 44 onto the central storage unit 94 is indexed and stored for later retrieval. In some applications, the data is stored indefinitely. In other applications, the data is stored for a prescribed period of time (e.g., 3 months, 1 year, 5 years, etc.) and is then automatically deleted from the central storage memory to provide storage capacity for new data. The central storage unit is operable to display multiple video simultaneously on a split screen. Alternately, multiple displays are utilized for the synchronized display of video frames.

In applications of the present invention in which the recording media 44 is a digital memory unit, each frame of video data is sequentially numbered. In this manner, video data cannot be altered or deleted from the recording media 44 or the central storage unit 94 without marking the recorded video data as having been altered.

FIGS. 1A and 1B illustrate a method of operating the data acquisition and display system 10 according to the present invention. In a first act 110, the data acquisition and display system 10 is activated when an operator depresses the POWER button. In some constructions, the data acquisition and display system 10 remains operational at all times and is only powered down during service and maintenance procedures. In other constructions, the data acquisition and display system 10 is powered down every time an operator completes his shift and returns the vehicle V to headquarters.

In act 112, the display screen 36 displays a data entry screen and the operator is prompted to input data (e.g., the operator's name, the operator's badge number, the vehicle identification number, a password, the operator's rank, etc.). In act 114, the controller 31 determines the operator's level of authority based upon the data input in act 112. If the operator is a supervisor (“YES” at act 114), the operator is granted open access to the data acquisition and display system 10 and the operator is allowed to delete data, edit existing data, and change settings and defaults. If the operator is not a supervisor (“NO” at act 114), the operator is granted limited access.

In act 116, the display screen 36 displays a main menu. From the main menu, the operator can activate the radio 50, shut down the data acquisition and display system 10, play previously recorded video data on the display screen 36, display video data on the display screen 36 in real time, record data, or mark a geographic location. To activate the radio 50, the operator presses the RADIO button in act 117 and operates the radio 50 in a conventional manner. To shut down the data acquisition and display system 10, the operator presses the POWER button in act 119 and the data acquisition and display system 10 shuts down. However, in some constructions, operators, and particularly operators having restricted access, are prevented from shutting down the data acquisition and display system 10.

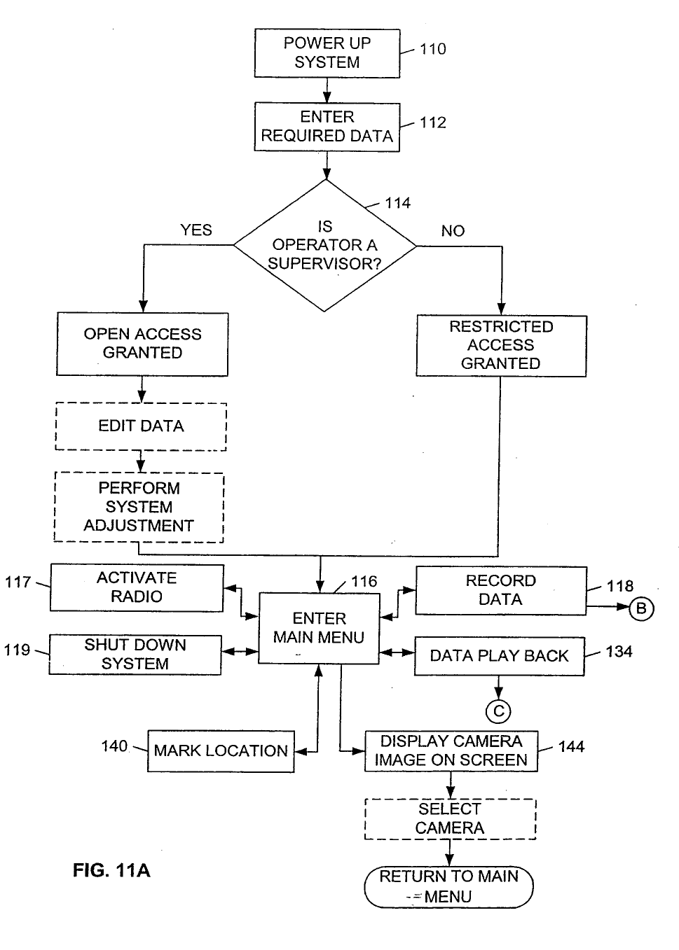

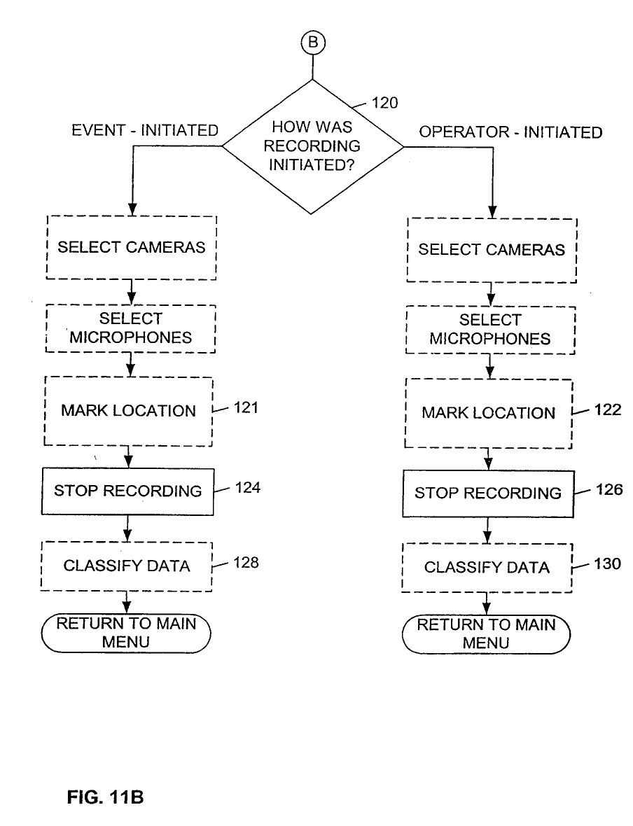

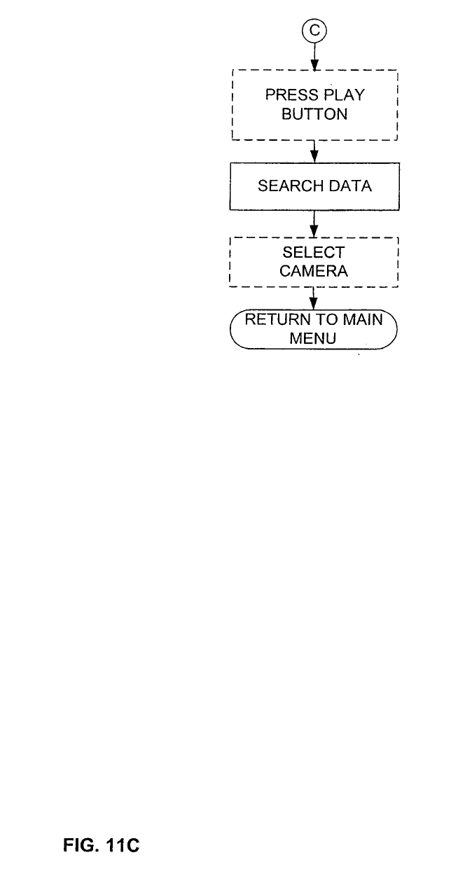

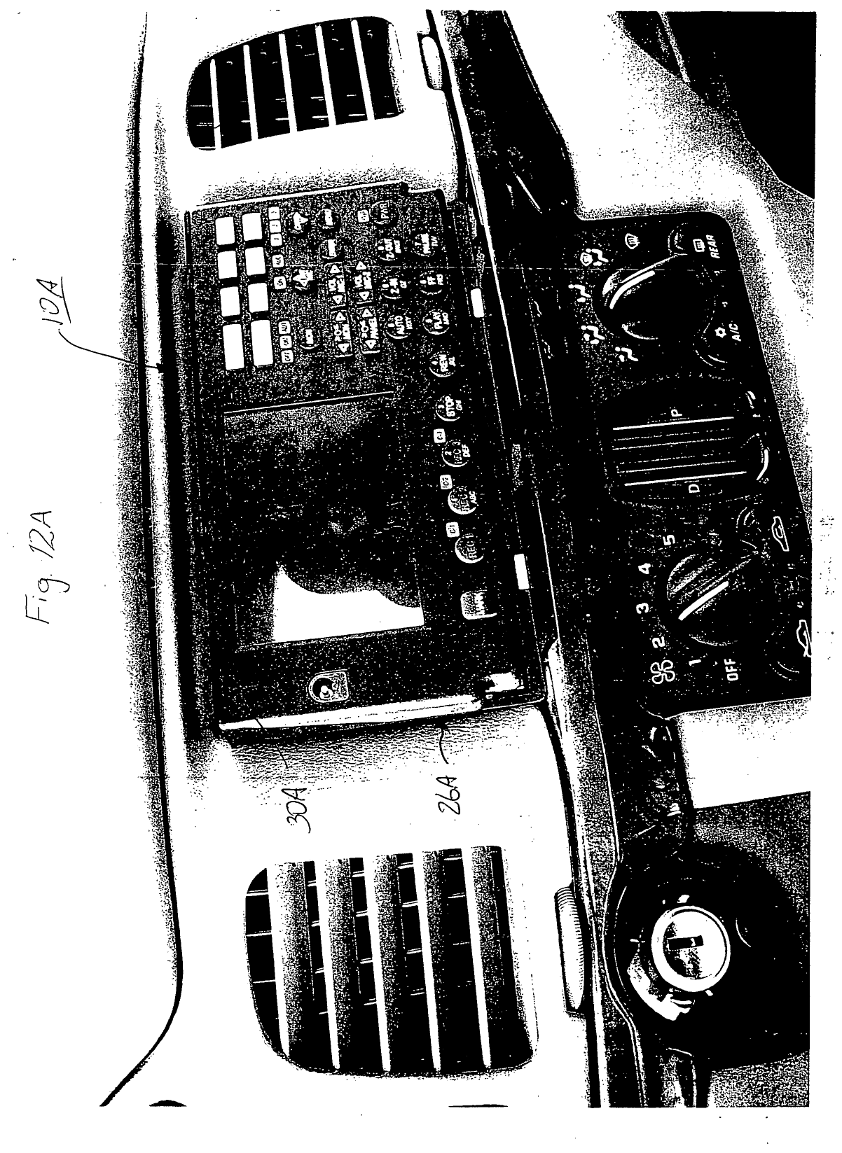

With reference to act 118, data recording can be initiated in either of two manners. First, in act 120 (see FIG. 11B), by selecting “OPERATOR-INITIATED” on the main menu, the operator can record video data from one of the cameras 62a, 62b, 62c, or alternatively, in constructions having two video channels, the operator can record video data from any two of the cameras 62a, 62b, 62c. Additionally, during OPERATOR-INITIATED recording, the operator can direct the controller 31 and the recording media 44 to record data from one or more of the first and second microphones 68a, 68b, the GPS engine 88, the clock 47, the speed measuring apparatus 77, and the vehicle sensors 92a, 92b, 92c, 92d. The recorded data is then transmitted to the controller 31 and the recording media 44 where the data is indexed and coordinated as described above for later retrieval.

Alternatively, “EVENT” recording can be initiated automatically in act 120 when any one of a number of events occurs. For example, in some constructions, EVENT recording is initiated when the operator activates the siren 14 and/or the light bar 12. Alternatively, EVENT recording can be initiated when the speed measuring apparatus 77 records speed data above a predetermined value (e.g., above 80 mph) and/or when the CALL button is depressed. During EVENT recording, the controller 31 and the recording media 44 automatically record data from two predetermined cameras 62 (e.g., the first and second cameras 62a, 62b), the first and second microphones 68a, 68b, the GPS engine 88, the clock 47, the speed measuring apparatus 77, and the vehicle sensors 92a, 92b, 92c, 92d. The recorded data is also indexed and coordinated as described above for later retrieval.

Once recording, either Operator-INITIATED or EVENT recording, is initiated the operator can alter the camera configuration so that, for example, the controller 31 and the recording media 44 record video data from the first and third cameras 62a, 62c. Also, the operator can deactivate and reactivate either of the microphones 68a, 68b. Additionally, after recording is initiated, the operator can mark a geographic location in acts 121, 122.

To ensure that the controller 31 and the recording media 44 record as much relevant data as possible, in some constructions, the data acquisition and display system 10 is programmed to continuously record video data, audio data, time and date data, vehicle status data, and vehicle location data for a predetermined time (e.g., one minute) and then to record over the previously recorded data. In these constructions, the recording media 44 continuously records data and then records over that data until OPERATOR-INITIATED or EVENT recording is initiated and once OPERATOR-INITIATED or EVENT recording is initiated, the recording media 44 saves the previously recorded data (e.g., about one minute of data) and all data collected after OPERATOR-INITIATED or EVENT recording is initiated until the operator presses STOP in act 124 or act 126. In this manner, the recording media 44 also stores data from a relatively short period before OPERATOR-INITIATED or EVENT recording is initiated and stores data collected after OPERATOR-INITIATED or EVENT recording is initiated. The data recorded before OPERATOR-INITIATED or EVENT recording is initiated provides context to the data recorded after OPERATOR-INITIATED or EVENT recording is initiated and can be of particular investigative and/or evidentiary value.

After recording is stopped, the operator can classify the recorded data in acts 128, 130. More particularly, in acts 128, 130, the operator can add a classification code to the recorded data so that the recorded data can be indexed and categorized by the classification code for later retrieval. The classification codes can be preset during system set up and can be reconfigured as needed. For example, in some constructions, the data display and acquisition system 10 can be programmed to include classification codes (e.g., 111, 112, 222, 333, etc.) for traffic violations (failure to yield, speeding violations, running a red light, etc.), domestic disturbances, robberies, and weapons related incidents (e.g., armed robbery, concealed weapons violations, etc.). In these constructions, the operator classifies the recorded data in acts 128, 130 by entering a number code (e.g., 111) using the number buttons 1, 2, 3 so that recorded data can later be retrieved according to classification code. Even further, the operator can provide Event Identification codes such as a case or ticket number to be associated with the classification code. A flag can also be set to indicate whether or not to keep the recorded event. It should be noted however that such designation would not cause the event to be erased/removed from the recording media 44.

In operation 128, 130, an Event Identification is provided in the following manner. After recording an event and pushing “stop,” an “Event ID” Screen is displayed to prompt and accept operator input. The operator may then interact with the system and respond to field prompts for values such a “Ticket/Case” number, e.g., 20045325. Another field requesting a “K” or “X” allows the operator to elect to keep or not keep the particular event. Another field is type of an event (traffic stop (routine), traffic stop (felony), traffic accident) or the operator may then select an event type from a predefined list, followed by a gender identifier (M—male or F—female). Next, an identification of race can be made using a previously defined list of options. In the event that an operator fails to provide event identification, default identification is provided by the system. Here also, as with other recorded parameters and data, the event identification is a searchable item. Searchable items may be used by the search engine of the central storage unit 94 of by the data acquisition and display system 10.

As shown in FIG. 11A, the operator can replay or review previously recorded data. To review previously recorded data, the operator selects “DATA PLAYBACK” on the main menu in act 134. The operator can then select video data to replay on the display screen 36 using the PLAY, FF, and REW buttons in a known manner. Additionally, during DATA PLAYBACK, additional recorded data, including vehicle location data, vehicle status data, vehicle speed data, and classification code data corresponding to the video data can also be displayed on the display screen 36 and audio data is broadcast over the vehicle speakers 51 simultaneously or nearly simultaneously with the corresponding video data. As explained above, in some constructions, the recording media 44 records data from two cameras 62 (e.g. 62a, 62b) simultaneously. In these constructions, operators can review data recorded by either of the two cameras 62 on the display screen 36 and can toggle between data recorded by either of the cameras 62 using the CAM button.

As explained above, the data acquisition and display system 10 includes a mark and search feature, which allows the operator to identify a given location based on GPS coordinates and to recall that location later, or alternatively, to provide the location data to other personnel (e.g., to a police dispatcher or to the occupants of a second vehicle). To mark a location, the operator depresses the MARK button in act 140. The controller 31 and the recording media 44 then save the location data generated by the global positioning system 80 at the time that the MARK button was depressed. The designated location data is then displayed on the display screen 36 to confirm that the data display and acquisition system 10 has recorded the location data.

To display images recorded by the cameras 62 on the display screen 36 in real time, the operator selects “DISPLAY CAMERA IMAGE ON SCREEN” from the main menu in act 144. In this manner, the operator can view data recorded by any one of the cameras 62 (e.g., the first, second, or third cameras 62a, 62b, 62c) in real time and can toggle between the cameras 62 using the CAM button. In this manner, the operator can discretely monitor activity occurring around the vehicle V and/or in the back seat of the vehicle V.

An alternate construction of a data acquisition and display system 10A is illustrated in FIG. 12. Common elements are identified by the same reference number “A”. In the illustrated construction, the vehicle V is a Chevrolet Impala.

A central portion of the console 22A defines an aperture 26A. In the construction illustrated in FIGS. 12A-12C, the aperture 26A is a double-din bin and the central unit 30 is configured and sized to be received in the aperture 26A. More particularly, the central unit 30 is configured and sized to be received in the double-din bin of a Chevrolet Impala.

The constructions described above and illustrated in the drawings are presented by way of example only and are not intended to limit the concepts and principles of the present invention. As such, it will be appreciated by one having ordinary skill in the art, that various changes in the elements and their configuration and arrangement are possible without departing from the spirit and scope of the present invention as set forth in the claims.

1. A data acquisition and display system for mounting in a vehicle, the system comprising:
a recording media mountable in the vehicle;
a global positioning system operable to calculate location data and being in communication with the recording media to transfer the location data to the recording media; and
a controller in communication with the recording media and the global positioning system, the controller including a mark feature for designating selected location data on operator command, the selected location data being saved on the recording media.

2. The data acquisition and display system of claim 1, wherein the recording media is a digital memory unit.

3. The data acquisition and display system of claim 1, further comprising a radio.

4. The data acquisition and display system of claim 3, wherein the vehicle includes a plurality of speakers, and wherein the radio generates sound and is in communication with the plurality of speakers to broadcast the sound.

5. The data acquisition and display system of claim 1, wherein the recording media is a digital memory unit and the recording media associates the location data and audio/video data, and further comprising a search engine in communication with the recording media and operable to search the recording media for at least one of the location data and audio/video data.

6. The data acquisition and display system of claim 1, further comprising a vehicle status data input in communication with the recording media to receive vehicle status data and to transfer the vehicle status data to the recording media.

7. The data acquisition and display system of claim 1, further comprising a traffic velocity recording system input in communication with the recording media to receive traffic velocity data and to transfer the traffic velocity data to the recording media.

8. The data acquisition and display system of claim 1, further comprising a clock and in communication with the recording media to provide time data to the recording media.

9. The data acquisition and display system of claim 1, further comprising a microphone in communication with the recording media to transmit audio data to the recording media.

10. The data acquisition and display system of claim 9, wherein the microphone is wireless.

11. The data acquisition and display system of claim 9, further comprising a controller in communication with the recording media, and wherein the microphone generates an alert signal in response to an operator input, the microphone being in communication with the controller to transmit the alert signal to the controller.

12. The data acquisition and display system of claim 11, wherein the controller broadcasts the alert signal to a remote receiver.

13. The data acquisition and display system of claim 12, further comprising a global positioning system operable to calculate location data and being in communication with the controller, the controller transmitting the location data to the remote receiver with the alert signal.

14. The data acquisition and display system of claim 1, further comprising an identifier corresponding to the data acquisition and display system, the recording media associating the video data and the identifier.

15. The data acquisition and display system of claim 1, further comprising:
a wireless microphone operable to generate an alert signal in response to a non-verbal operator input and to transmit the alert signal to the recording media.

16. The data acquisition and display system of claim 15 further comprising:
a global positioning system operable to calculate location data and being in communication with the recording media, the recording media coordinating the location data and the alert signal.

17. The data acquisition and display system of claim 15, wherein the alert signal is broadcast to a remote receiver.

18. A method of recording data in a vehicle, the method comprising:
providing a data acquisition and display system including a recording media, a global positioning system in communication with the recording media, and a controller in communication with the recording media and the global positioning system;
calculating location data with the global positioning system;
designating selected location data with the controller;
saving the selected location data on the recording media; and
recalling the selected location data from the recording media to direct an operator to a location corresponding to the selected location data.

19. A method of recording data with a vehicle mounted data acquisition and display system including a video camera operable to record video data, a recording media operable to store the video data, a vehicle sensor positioned in the vehicle for recording vehicle status data, and a controller in communication with the recording media and the vehicle sensor;
recording the video data over previously recorded video data on the recording media in a first recording cycle; and
initiating a second recording cycle in response to vehicle status data received by the controller, during the second recording cycle, the recording media not deleting the previously recorded data.

20. A method of cataloging video data in a vehicle, the method comprising:
providing a data acquisition and display system including a video camera for recording video data and a recording media in communication with the video camera;
providing a plurality of identifiers corresponding to types of data;
transmitting the video data to the recording media;
saving the video data on the recording media;
assigning one of the plurality of identifiers to the video data, the recording media being searchable for at least one of the identifier and the video data.

21. A method for inhibiting tampering with video data and making the video data tamper evident comprising:
providing a video data acquisition system operable to record frames of data; numbering each frame of data with a unique identification.

22. The method of claim 21, wherein said numbering of each frame is in base 10.

23. The method of claim 21, wherein said numbering of each frame is in base 36.
